(19) United States
(12) Patent Application Publication
(10) Pub. No.: US 2026/0212774 A1
(43) Pub. Date: Jul. 23, 2026

(54) SYSTEMS AND METHODS FOR ASSESSING SOCIAL SKILLS IN VIRTUAL REALITY

(71) Applicant: NEO AUVRA DIJITAL SAGLIK VE BIYONIK TEKNOLOJI VE HIZMETLERI SANAYI VE TICARET A.S, Istanbul (TR)

(72) Inventors: Tarcan KIPER, Istanbul (TR); Ömer Kerem ÖZÇAKIL, Istanbul (TR); Korhan GÖKSU, Istanbul (TR)

(21) Appl. No.: 19/142,141

(22) PCT Filed: Dec. 22, 2023
(86) PCT No.: PCT/IB2023/063195

§ 371 Date: Jun. 20, 2025

Related U.S. Application Data
(60) Provisional application No. 63/434,624, filed on Dec. 22, 2022.

(51) Int. Cl. G09B 5/06; G06F 3/01; G06T 13/40; G06T 19/00

(52) U.S. Cl. CPC G09B 5/06; G06T 13/40; G06T 19/00; G06F 3/013

(57) ABSTRACT

Systems and methods provided in this disclosure explain the use of interactive narratives in VR to derive performance metrics for the assessment of individuals'socio-emotional skills. It also provides an explanation of how the change of narrative flow can be configured according to user responses, and how this changing nature of narratives can be used for more valid socio-emotional skills assessment for better prediction of real-life performance in targeted domains.

### BACKGROUND

### Field

The present disclosure is generally directed to assessing socio-emotional skills using a virtual reality (VR) based interactive narrative.

### Related Art

Socio-emotional skills beyond social cognition display their true potential in social interaction, where individuals receive direct feedback from the person(s) they interact with. Conventional methods for socio-emotional skills assessment consist of paper-and-pencil tests, interviews, or role-playing. Paper-and-pencil assessments provide a large amount of data in a short time, but they lack the interactive nature of social interactions. Therefore, data provided by paper-and-pencil tests have weak ecological validity for real-life assessment. Interviews and role-playing methods try to fill this gap and reach more detailed results by mimicking the interactive nature of social interactions. However, these methods require a long time that may last for days for a comprehensive evaluation.

Accordingly, there is a need for the development of interactive, brief, and compact assessment systems for the comprehensive evaluation of socio-emotional skills. This disclosure relates to interactive narrative systems for an automated, detailed, and comprehensive assessment of socio-emotional skills in virtual environments.

### SUMMARY

The present disclosure provides a system and methods for socio-emotional skills assessment of individuals (or subjects) in one or more targeted domains for predictive evaluation of real-life socio-emotional skills. The disclosed assessment system and methods consist of the testing phase and calculation of the individual's score(s) in a targeted domain(s) based on an individual's responses during the testing phase. The testing phase comprises the process of the individual taking the test, giving their responses, and recording and storing the individual's responses. Based on their scores, the present disclosure provides a comparison of individuals with each other in terms of their socio-emotional skills.

The present disclosure also demonstrates the method of using interactive-narrative design, often used in video games (e.g., serious video games designed for a purpose other than mere entertainment), for individual socio-emotional skills assessment. The system and method comprise a display of instructions to an individual, a flow of a test narrative according to individual's responses, a user interface used for obtaining individual's responses, and calculation of individual's responses according to narrative flow to determine observable characteristics of the individual in social interaction.

In some aspects, the techniques described herein relate to a system including: a non-transitory computer readable medium configured to store information and executable programmed modules; a VR apparatus configured to provide audio and visual stimuli to a subject during an evaluation session; and a processor communicatively coupled with the non-transitory computer readable medium and the VR apparatus, the processor configured to execute programmed modules stored in the non-transitory computer readable medium, the processor configured to: control the evaluation session to provide an introduction corresponding to the evaluation session, wherein the evaluation session includes a plurality of scenes, each scene having one or more of a set of one or more virtual characters, one or more animations applied to the one or more virtual characters, displayed text, audio vocalizations of at least a portion of the displayed text, and one or more virtual user interface elements configured to register one or more responses from the subject during the evaluation session; control the VR apparatus to provide audio and visual stimuli corresponding to a first scene of the plurality of scenes for the evaluation session, wherein the audio and visual stimuli include at least a first prompt; receive from the VR apparatus a first response to the first prompt from the subject; store the first response in the non-transitory computer readable medium in association with a timestamp corresponding to when the first response was received from the subject and a time duration corresponding to an elapsed time between when the first prompt was provided to the subject and when the first response was received from the subject; select, based on the first response, a second scene for the evaluation session; control the VR apparatus to provide audio and visual stimuli corresponding to the second scene of the plurality of scenes for the evaluation session, wherein the audio and visual stimuli include at least a second prompt; receive from the VR apparatus a second response to the second prompt from the subject; store the second response in the non-transitory computer readable medium in association with a timestamp corresponding to when the second response was received from the subject and a time duration corresponding to an elapsed time between when the second prompt was provided to the subject and when the second response was received from the subject; select, based on the second response, a third scene for the evaluation session; continue to deliver scenes to the subject and receive responses from the subject until a last scene in the plurality of scenes for the evaluation session has been delivered; and analyze the stored responses from the subject and the corresponding timestamps and time durations to calculate a skill score for the subject related to the evaluation session.

In some aspects, the techniques described herein relate to a method including: providing, via a VR apparatus configured to provide audio and visual stimuli to a subject during an evaluation session, an introduction corresponding to the evaluation session, wherein the evaluation session includes a plurality of scenes, each scene having one or more of one or more virtual characters, one or more animations applied to the one or more virtual characters, displayed text, audio vocalizations of at least a portion of the displayed text, and one or more virtual user interface elements configured to register one or more responses from the subject during the evaluation session; providing, via the VR apparatus, audio and visual stimuli corresponding to a first scene of the plurality of scenes for the evaluation session, wherein the audio and visual stimuli include at least a first prompt; receiving from the VR apparatus a first response to the first prompt from the subject during a first scene; storing the first response in association with a timestamp corresponding to when the first response was received from the subject and a time duration corresponding to an elapsed time between when the first prompt was provided to the subject and when the first response was received from the subject; selecting, based on the first response, a second scene for the evaluation session; providing audio and visual stimuli corresponding to the second scene of the plurality of scenes for the evaluation session, wherein the audio and visual stimuli include at least a second prompt; receiving from the VR apparatus a second response to the second prompt from the subject during the second scene; storing the second response in association with a timestamp corresponding to when the second response was received from the subject and a time duration corresponding to an elapsed time between when the second prompt was provided to the subject and when the second response was received from the subject; selecting, based on the second response, a third scene for the evaluation session; continuing to deliver scenes to the subject and receive responses from the subject until a last scene in the plurality of scenes for the evaluation session has been provided; and analyzing the stored responses from the subject and the corresponding timestamps and time durations to calculate a skill score for the subject related to the evaluation session.

### BRIEF DESCRIPTION OF DRAWINGS

FIG. 1 is a diagram illustrating components of a system for assessment of one or more areas of social and/or emotional skills in accordance with some aspects of the disclosure.

FIG. 2 is a schematic diagram of an embodiment of a system according to an aspect of the present disclosure.

FIG. 3 is a flow diagram illustrating an example method of assessing a set of one or more skills in accordance with some aspects of the disclosure.

FIG. 4 is a flow diagram illustrating an example method of performing an assessment via the VR system in accordance with some aspects of the disclosure.

FIG. 5 is a flow diagram illustrating an example method of providing a VR experience associated with an assessment via the VR system in accordance with some aspects of the disclosure.

FIG. 6 is a diagram illustrating a structure of a socio-emotional scenario in accordance with some aspects of the disclosure.

FIG. 7 is a diagram illustrating an example of a generated report in accordance with some aspects of the disclosure.

FIG. 8 is a graph diagram illustrating an example graphical representation of the assessment that may be included in a generated report in accordance with some aspects of the disclosure.

FIG. 9 is a flow diagram illustrating a method in accordance with some aspects of the disclosure.

FIG. 10 is a flow diagram illustrating a method in accordance with some aspects of the disclosure.

FIG. 11 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

It should be noted and appreciated that the combination of concepts explained herein is the inventive subject matter of the presented disclosure. Therefore, it should be recognized that terminology used herein may appear in any disclosure. However, their meanings which are explicitly given in this disclosure should be accorded a meaning most related to the specific concepts disclosed herein.

The term “interactive narrative,” as used in the present disclosure, refers to tasks with a narrative structure in VR that a subject is instructed to complete and whose flow changes according to the subject's response. This responsive structure of interactive narrative provides immediate feedback to the subject's response. In this way, interactive structures of social relationships may be mimicked.

Interactivity in the narrative may become prominent by virtual characters'reactions and pre-designed responses. “Virtual characters” as used in here, refers to the 3D modeled and rendered characters developed in computerized environments. Design and development of characters can be based on character requirements in the narrative, assessment requirements, such as for specific groups, competencies or occupations, and task requirements. For example, a female, middle-aged, European, manager character can be required, designed, and developed for assessment of leadership and conflict management skills.

Also, interactivity in the narrative may become prominent through object manipulations or scene manipulations. “Object manipulations” as used in here, may refer to changes in locations, forms, or shapes of 3D objects in the 3D environment. Both 3D objects and environments are the 3D modeled and rendered objects and environments developed in computerized environments. “Scene” as used in here, refers to the part (or episode) that provides the narration of the story, including the environment, objects, characters, and the flow of the story. “Scene manipulations” as used in here may refer to changes in any of these concepts separately or together.

The present specification discloses how interactive narratives as introduced above are used for socio-emotional skills assessment. An individual or a subject may be tasked to experience and give his/her responses according to virtual characters'reactions, scene manipulations, or object manipulations in an interactive narrative designed for the assessment of targeted socio-emotional skill. The task itself may have a specific objective and this objective may or may not be explicitly given to the subject.

The task content, brief explanation, and instructions before and during the interactive narrative may be presented to a subject (or user) by a designed User Interface (UI). UI may comprise written texts, vocalization of written texts, a timer, and buttons for user responses. Content of the instructions and written texts may change according to task objective, and narrative flow. A subject may interact with virtual characters and respond to changes in virtual characters'reactions, object manipulations, and scene manipulations via a UI. Subject responses are collected by recording user inputs via a UI. “Timer” as used in here refers to the visualization of remaining time that is for a user to give his/her response via the UI. “Buttons” as used in here may refer to visualization “Thought Options (TO)”, “Dialogue Options (DO)”, or “Action Options (AO)”.

An example system according to the specifications in here a “Dialogue Options (DO)” may refer to possible responses a user can give via UI buttons according to any instructions, virtual characters'reactions, object manipulations, and/or scene manipulations, and that may trigger any of another instruction, virtual character reaction(s), object manipulation(s), or scene manipulation(s). Similarly, “Thought Options (TO)” may refer to possible responses a user can give via UI buttons according to any instructions, virtual characters'reactions, object manipulations, and/or scene manipulations, but that may or may not trigger any of another virtual character reaction(s), object manipulation(s) or scene manipulation(s). Also, “Action Options (AO)” may refer to possible responses a user can give via UI buttons according to any virtual characters'reactions, object manipulations, and/or scene manipulations, but that may or may not trigger any another virtual character reaction(s), object manipulation(s) or scene manipulation(s).

In the following description, numerous specific details are set forth to provide a thorough understanding of the systems and methods disclosed herein. It will be apparent, however, to one skilled in the art that the systems and methods disclosed herein may be practiced without some or all these specific details. In other instances, well known process steps and/or structures have not been described in detail to not unnecessarily obscure the disclosed systems and methods.

The systems and methods described herein generally relate to the assessment of social skills in virtual reality. In particular, the systems and methods described herein provide a system and method for using interactive narratives in virtual reality to derive performance metrics for the assessment of individuals'socio-emotional skills.

The systems described herein comprises a computer-implemented method that includes providing a set of one or more VR scenarios that are simulations that take place in a virtual reality environment. The VR scenarios are designed to simulate a real-world social interaction, comprising an interactive narrative to a test taker. Each interactive narrative may be configured to elicit different social skills responses, presenting a test taker with a scaled version of the interactive narrative, and monitoring the user during the interactive narrative to derive performance metrics, including but not limited to measuring their biometric signals, body language, movements, dialogue option (DO), action option (AO), and thought option (TO) choices, and interactions within the VR scenario. At the end of the test, the subject's given responses and nonresponses may be analyzed and used for a calculation similar to the calculation of scale/questionnaire responses in socio-emotional skill assessments in the literature. Obtained biometric data may be used for further analysis of the user's responses. The results of these analyses will be used for the evaluation of the user's socioemotional skill performance in the selected domain of the assessment.

The disclosed system may be used to assess various socio-emotional skills, including but not limited to: empathy, assertiveness, self-regulation, communication, social perception, conflict management, social learning, self-awareness, self-esteem, and resilience.

The system, in some aspects, comprises a plurality of modules that work together to provide an immersive and realistic experience for the user, while at the same time gathering data that can be used to assess different socio-emotional skills.

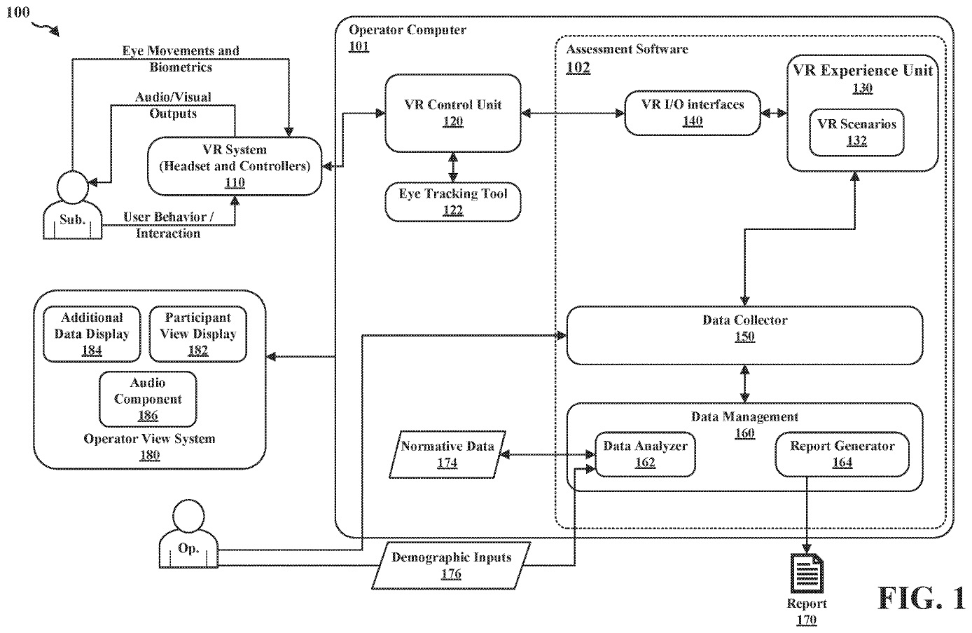

FIG. 1 is a diagram illustrating components of a system 100 for assessment of one or more areas of social and/or emotional skills in accordance with some aspects of the disclosure. The components and/or the system may be associated with one or more of socio-emotional VR experiences, data collection (e.g., via a NEO AUVRA Data Collector), and participant data management (e.g., a NEO AUVRA Participant Data Manager). In some aspects, the system and its assessment algorithms may be designed to be scalable to allow for multiple VR experiences, multiple biosensors, and multiple features available today and/or developed in the future.

Assessment software 102 may be run on an operator computer 101 (as a non-limiting example of hardware executing software). The assessment software 102 may be associated with a first set of elements (e.g., VR experience unit 130 and a set of VR I/O interfaces 140) associated with interacting with a VR device and/or program to provide a VR experience (or other audio/visual stimuli), a data collector 150, and a data management component 160 (where data management may include data management and data analysis components). For example, a VR experience unit 130 may be configured to provide instructions for providing a VR experience (e.g., audio and visual stimuli) to a subject via a set of VR I/O interfaces 140 to a VR control unit 120 executing on a same operator computer 101 (or, in alternative aspects, on a different computer). The instructions, in some aspects, may be based on a VR scenario in a set of VR scenarios 132. The VR control unit 120 may control a VR system 110 (alternatively referred to as a VR apparatus or VR device) including a headset (e.g., including a display and earphones) and one or more controllers (e.g., a handheld device used to manipulate the VR environment based on the position and orientation of the handheld device and/or based on the use of triggers or buttons on the handheld device). The VR system 110, in some aspects, may include, or be associated with, additional feedback (e.g., input) and/or monitoring systems, for tracking eye movement, head pose (e.g., position and orientation), controller pose, or other aspects involved in providing a VR experience and updating the VR experience in real time based on behaviors of the subject. The VR system 110, in some aspects, may be used to provide immersive virtual environments (IVEs) in which a subject completes one or more assessment tasks. The IVEs are designed to be realistic and engaging and to provide one or more socio-emotional, cognitive, and/or physical challenges.

The VR system 110 may communicate feedback and/or other collected data regarding eye movement, head pose, controller pose, etc. to the VR control unit 120 to update the VR experience (e.g., to update the audio and/or visual stimuli based on, for example, a subject turning their head to view a different area of the virtual environment). The VR control unit 120 may interact with an eye tracking tool 122 to interpret eye movement data and provide, for example, an indication of a focus of the subject's attention. The feedback and other collected data may then be provided to the VR experience unit 130 via the set of VR I/O interfaces 140 to be provided to the data collector 150 and to be used to determine a next scene (or scenario) if a current scene (or scenario) has ended. For example, the VR experience unit 130 may provide, to the data collector 150, information regarding the VR experience (e.g., the audio and visual stimuli and the feedback and/or collected data received via the VR system 110). For example, the subjects may experience virtual environments via the VR system (e.g., via the headset and controllers) and 6 degree of freedom (DoF) data (e.g., position along each of three axes and rotation around each of three axes) may be logged throughout the experience (e.g., at a first frequency allowing for smooth operation) to obtain the collected data. The data provided to the data collector 150 may be associated with time stamp or other metadata to allow the data collector 150 or the data management component 160 to synchronize or otherwise identify related data.

In some aspects, the set of VR I/O interfaces 140 may include an Unreal Engine. and an SRanipal Plugin (or SRanipal software development kit (SDK) module). For example, in some aspects, the IVEs may be powered by the Unreal Engine, such that the main features (e.g., graphics, physical simulations, user interfaces, user interactions, artificial intelligence, networking, etc.) are handled by the Unreal Engine. The input to the Unreal Engine (e.g., binaries and assets), in some aspects, may be included in the code and content of the VR experience unit 130 or the set of VR scenarios 132. In some aspects, the SRanipal SDK module is an eye-tracking SDK used to interface with an eye-tracking hardware module of the VR headset of the VR system 110. For example, the SRanipal plugin may be a C++ plugin code to log eye tracking data and output this data to the VR experience unit 130, the data collector 150, and/or the data management component 160. The SRanipal plugin, in some aspects, may collect data by communicating with the SRanipal SDK. SRanipal plugin code may compiled in IVEs and used in IVEs by Unreal Engine. While the previous discussion uses the examples of the Unreal Engine and the SRanipal Plugin (or SRanipal SDK module), they are used as non-limiting examples of software modules that may be used to provide a VR experience (e.g., an IVE) and/or eye tracking data.

In some aspects, the data collector 150 (e.g., a NEO AUVRA Data Collector) may be a Windows-based custom software to perform assessments (e.g., cognitive, socio-emotional, and/or physical assessments). The assessment software 102, in some aspects, may be scalable to collect data from various wearable sensors simultaneously during the tests and then to parse the data post collection (e.g., batch processing performed at the end of an assessment or provided scenario). In some aspects, the data collector 150 may be used to start the tests and then to preprocess the test data (e.g., parse the data). The data collector 150, in some aspects, may initiate the data management component 160.

The software is designed to be used by one or more operators. For example, an operator may sign in to the data collector 150 with a subject's user ID (e.g., a unique number generated for each subject). Once a particular subject is identified the operator may collect and enter demographic inputs 176 to the data management component 160. The data management component 160, in some aspects, may also be provided with normative data 174 relating to population-level information related to the assessments (e.g., gaussian curves for response times, eye movements (focus times, number of saccades, etc.) or other measured behaviors). In some aspects, the data management component 160 may be configured to perform an analysis of the collected data (e.g., via data analyzer 162) and generate a report 170 of the results for the subject (e.g., via report generator 164) including scores for different areas and an indication of the meaning of the scores and a comparison to other subjects (e.g., a general population or the population of subjects).

In some aspects, the operator computer 101 may also provide an operator view system 180. The operator view system 180, in some aspects, may include one or more display areas on one or more physical displays and audio output for the operator to monitor the subject. For example, the operator view system 180, in some aspects may include a participant view display 182 showing the visual output provided to the subject, an audio component 186 outputting the audio provided to the subject, and one or more additional data displays 184 showing a visual representation of the output of one or more biosensors (e.g., a heart rate monitor, photoplethysmogram (PPG) data, galvanic skin response (GSR) data, heart rate variability (HRV) data, electroencephalography (EEG) data, etc.) or a security camera feed (e.g., for visual monitoring of the subject) used by the operator to monitor the state of the subject and to ensure the proper functioning of the VR system 110 and the assessment as a whole.

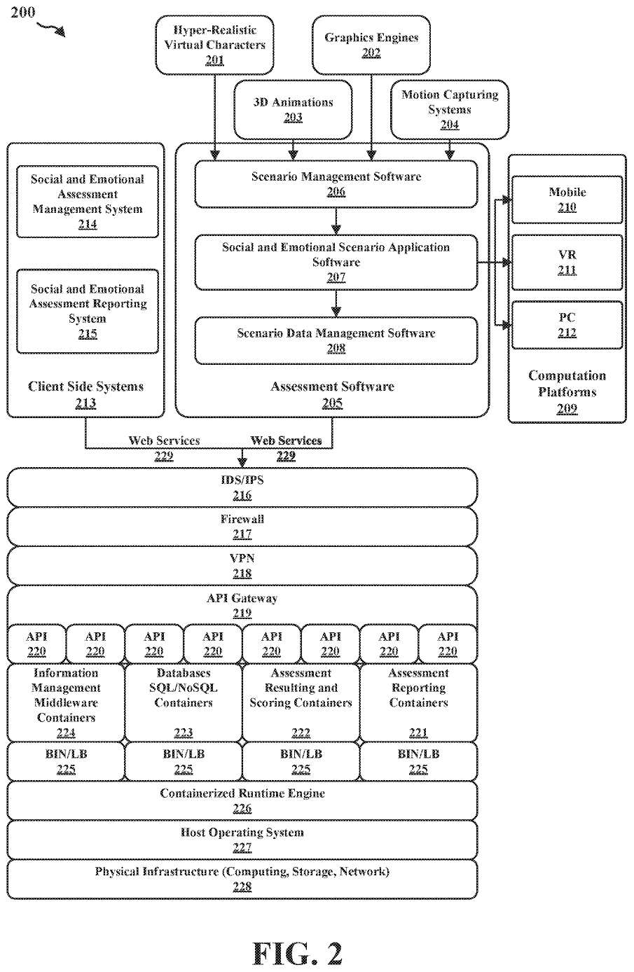

FIG. 2 is a schematic diagram of an embodiment of a system 200 according to an aspect of the present disclosure. In some embodiments, the system 200 comprises one or more computing devices operably connected over a network, such that at least one 3D graphics engine 202 is configured to create a believable virtual reality environment in which users can interact with the hyper-realistic virtual characters 201 that display humanlike emotions and social cues. In some embodiments, motion capturing systems 204 provide realistic movement and bodily expressions input data for the 3D animations 203 including but not limited to the movements, facial expressions, and dialogue of the virtual characters 201. In some embodiments, the system 200 may use animations of the virtual characters 201. In other embodiments, the system 200 may use pre-recorded footage of real people that is computer-generated to render the virtual characters 201. In some embodiments, motion capturing systems 204 are used to create lifelike facial expressions. In certain embodiments, the system 200 may also use a combination of computer-generated graphics and real-life footage.

Assessment software 205 (e.g., “NEO AUVRA Suite software” (NA-SS)), in some aspects, may be a set of software including, and/or providing an interface between, a scenario management software 206 (SMS) (e.g., “NEO AUVRA Scenario Management Software” (NA-SMS)), social and emotional scenario application software 207 (SESAS) (e.g., “NEO AUVRA Social & Emotional Scenario Application Software” (NA-SESAS)), and scenario data management software 208 (SDMS) (e.g., “NEO AUVRA Scenario Data Management Software” (NA-SDMS)). The SMS 206 may be used for managing and configuring SESAS 207 scenarios to be experienced by the subjects. The SESAS 207 interacts with the subject (or user) in the VR scenario and captures data related to the subject's social skills assessment and training. This data is processed and stored by the SDMS 208 which produces results that are stored in databases.

The subject, in some aspects, interacts with the system 200 through one or more computation platforms 209, which can include but are not limited to: a mobile device 210 (phones, tablets), a PC 212 (laptops, desktop computers), and a VR headset 211. These computation platforms 209, in some aspects, receive inputs from various types of sensors including but not limited to: microphones, accelerometers, gyroscopes, etc., which can track the subject's body movements, gestures, voice, and bio-signals in certain embodiments. In some embodiments the assessment software 205 components (SMS 206, SESAS 207, and SDMS 208) may be provided by a separate set of computation platforms 209 that run or are hosted on the same or different devices or web servers (e.g., using a cloud infrastructure, including but not limited to cloud providers like AWS, Azure, etc.), depending on client specific requirements.

In some embodiments, the system comprises a VR headset 211 (also known as a head-mounted display or HMD) used to display the virtual environment (the VR experience or IVE) and to provide controller, position, rotation, and locomotion input to the virtual environment. The VR headset 211, in some aspects, may be operably connected to the 3D graphics engine 202 via the SESAS 207. The head-mounted display of the VR headset 211 may include any device that can display a virtual reality environment, including but not limited to: an HTC Vive Pro Eye, an Oculus Quest 2, and an HP Reverb G2 Omnicept. In one embodiment, the SESAS 207 may provide scenarios (SESAS scenarios) to run (e.g., to be executed) on a PC 212 that is connected to a VR headset 211 via a data cable or other wired or wireless connections. In another embodiment, the SESAS scenarios run on a wireless standalone VR headset 211 with higher computational power and graphic processing capabilities. In these embodiments, the respondent experiences the SESAS scenarios via the VR headset 211. In other embodiments based on a mobile device 210 (including but not limited to: an iPhone, an iPad, a Samsung Galaxy), the 3D graphics engine 202 may be used in conjunction with a mobile application (“app”) running on the mobile device 210 to provide a non-immersive virtual reality environment to the subject, to be viewed from the device's display, including a 2D mobile experience, or “extended reality” (XR) applications also known as “augmented reality” (AR) or “mixed reality” (MR). In these embodiments, the respondent experiences the SESAS scenarios by looking at the mobile device 210 with or without a VR headset 211, with the 3D graphics engine 202 rendering the virtual environment on the mobile device 210 display.

In some embodiments, the system 200 also includes web services 229 that are used to communicate between client-side systems 213 which include a social & emotional assessment management system (SEAMS) 214 and a social & emotional assessment reporting system (SEARS) 215. The client-side systems 213 may be used by the subject or respondent to input assessment configuration details as well as receive assessment results. The web services 229 provide APIs that enable communication between the client-side systems 213 and other system 200 components including but not limited to: assessment software 205, SMS 206, SDMS 208, and computation platforms 209. In some embodiments, this communication is implemented using an HTTPS connection with secure certificate authentication (SSL/TLS).

In some aspects, the subject data captured by assessment software 205 and SDMS 208 is sent to one or more web services 229. In these aspects, the web services 229 provide an interface for subjects to access and operate SDMS 208. Furthermore, in some embodiments the web services are hosted on a physical infrastructure 228 behind security measures, securing server-side components which would be accessible from Internet. These security measures can include intrusion detection/prevention systems (IDS/IPS) 216, a firewall 217, a virtual private network (VPN) 218, and API gateway 219 to perform security measures such as to rate limit, throttle traffic, perform authentication checks using standard protocols. API gateway 219 including multiple API modules 220 are provided for various blocks in order to allow different levels of access to assessment reporting containers 221, assessment resulting and scoring containers 222, databases SQL/NoSQL containers 223, information management middleware containers 224, BIN/LIB Modules 225, and containerized runtime engine 226 that are deployed on a variety of host operating systems 227 (including but not limited to Linux distributions such as Ubuntu, Debian, Centos, Windows Server, etc.). Physical infrastructure 228 (computing, storage, and networking) is used to support the system.

In some embodiments of the system 200 architecture as shown in FIG. 2, certain features are optional while others may be combined or rearranged in different orders than what is shown. It should also be appreciated that additional or alternative features can be included in the system 200 without departing from the spirit of this disclosure.

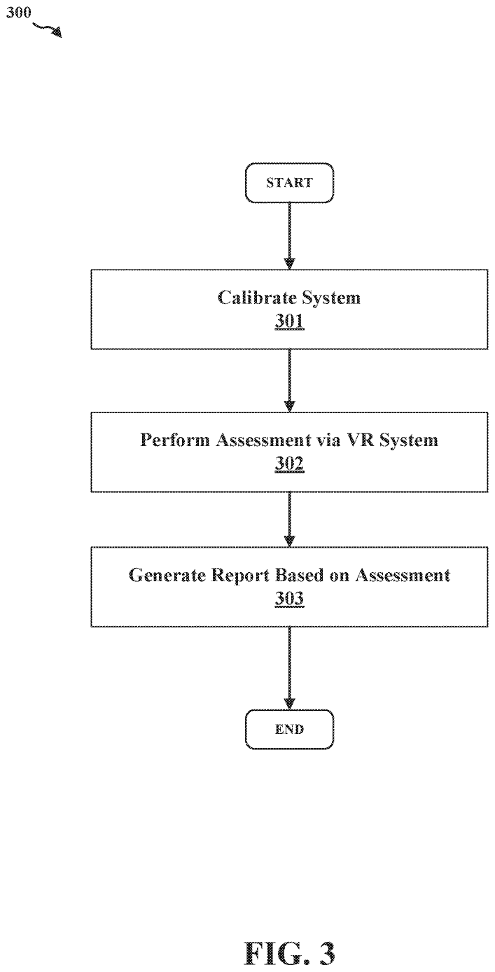

FIG. 3 is a flow diagram illustrating an example method 300 of assessing a set of one or more skills in accordance with some aspects of the disclosure. The method may be performed by the systems illustrated in FIGS. 1 and 2 (e.g., the assessment software 102, or the assessment software 205 and client-side systems 213). The method may begin after a subject has been equipped with a VR system and any additional monitoring equipment desired by an operator. At 301, an operator may calibrate the system for the subject. In some aspects, the calibration may include a VR familiarization procedure and/or experience. For example, a VR familiarization experience may be configured (or programmed) to help subjects to familiarize themselves with one or more of: the 3D environment of the VR, their own representation in the VR environment, mechanics and interactions they are going to use in further assessments, etc.

For example, a VR familiarization experience may include a subject in a park environment, sitting on a chair and looking around. The subject may be instructed to perform several mini tasks starting from observing people, animals, and objects in the environment (e.g., to calibrate eye movement, tracking, and/or focus). The subject may then be instructed to wave their hand to a non-player character (NPC) who is also waving their hand back to the subject. In this way, participants may perceive their virtual hands'position in the virtual environment in relation with the position of one or more controllers in the real world. The subject may also be instructed to perform other tasks such as opening a basket and grabbing objects within the basket to get used to utilizing their virtual hands for several other interactions. During all of this process, behavioral data and eye-tracking data may be collected simultaneously to track participants'learning performance.

In some aspects, throughout the calibration and assessment, every action of the participant such as interaction, grasping, using, and engaging may be logged by a log component (e.g., VR control unit 120, VR experience unit 130, or data collector 150 of FIG. 1). The interaction log file generated based on the logging, in some aspects, may include a System UnixTimeStamp, MilliSeconds SinceStart, ActionLatency, ActionType, Hand, PanelPage, GrabItem, TeleportGrid, SnappedItemSuccess, and/or SnappedItemFail data.

After calibration at 301, the system may proceed to perform the assessment via the VR system at 302. While described as being provided by the VR system, the assessment may be performed using other (e.g., 2D) systems. The assessment performed at 302, in some aspects, may include multiple sub-assessments covering multiple skill areas or types of skills. For example, an assessment may include sub-assessments (e.g., scenarios) relating to one or more empathy, assertiveness, self-regulation, communication, social perception, conflict management, social learning, self-awareness, self-esteem, or resilience. In some aspects, the sub-assessments may each relate to a single skill area or type of skill, while in other aspects, one or more sub-assessments may each relate to a subset of the multiple skill areas. As discussed above, performing the assessment may include providing one or more VR experiences (or IVEs) to a subject, and recording (or collecting) biological data (e.g., eye movement, head pose, hand position/orientiation) and feedback.

At 303, the system may generate a report based on the assessment (e.g., based on the data collected and recorded (or stored) during the assessment and an analysis of such data). In some aspects, generating the report may include comparing data regarding response times (e.g., a time from providing a prompt for an input or selection from the subject to receiving the requested input or selection), the content of the responses, eye movements, behavioral data, etc. to other subjects or gaussian distributions derived from other subjects to determine a score for one or more skills or skill areas.

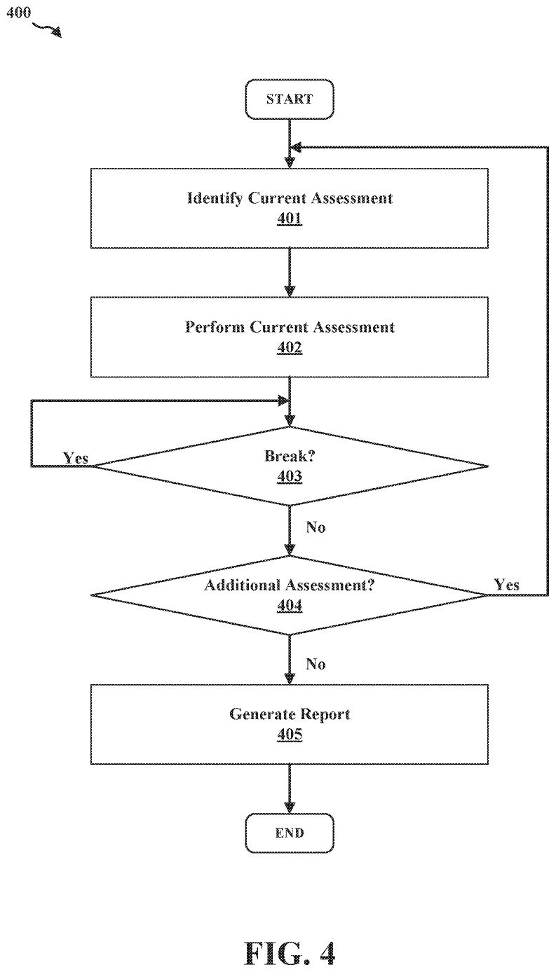

FIG. 4 is a flow diagram illustrating an example method 400 of performing an assessment via the VR system in accordance with some aspects of the disclosure. In some aspects, the method 400 may be an example of performing the assessment via the VR system at 302 of FIG. 3. The method 400 may be performed by the systems illustrated in FIGS. 1 and 2 (e.g., the assessment software 102, or the assessment software 205 and client-side systems 213). An assessment may begin at 401 by identifying a current assessment. For example, the system may determine a particular skill or area (e.g., a particular aspect of socio-emotional skills) being assessed. After determining the current assessment to be performed at 401, the system may proceed to perform the current assessment at 402. To perform the assessment for a particular skill or area, the system may present one or more scenarios to a subject via the VR system (e.g., the VR system 110 of FIG. 1 or VR headset 211 of FIG. 2). The subject may interact with virtual characters, virtual objects, and other elements of the virtual environment while the system collects data regarding the interactions (including selections made in response to prompts) along with eye tracking, head tracking, controller tracking, and other collected data.

After the system performs the current assessment at 402, the system may determine if a break will be provided at 403. A break may be provided between different types of assessments for the subject's sake or to adjust hardware based on one or more sensors or systems used for a current assessment that is not used for a subsequent assessment (or vice versa). If the system determines to take a break at 403, it may return to 403 to determine if an additional break will be provided.

After determining to not provide a break at 403, the system may proceed to determine if an additional assessment will be provided at 404. If the system determines to provide an additional assessment at 404 the system may return to identify a current assessment at 401. If the system determines not to provide an additional assessment at 404, the system may generate a report at 405. The report may be generated based on the data collected while performing the assessment(s) at 402 (similar to the report generation at 303 of FIG. 3).

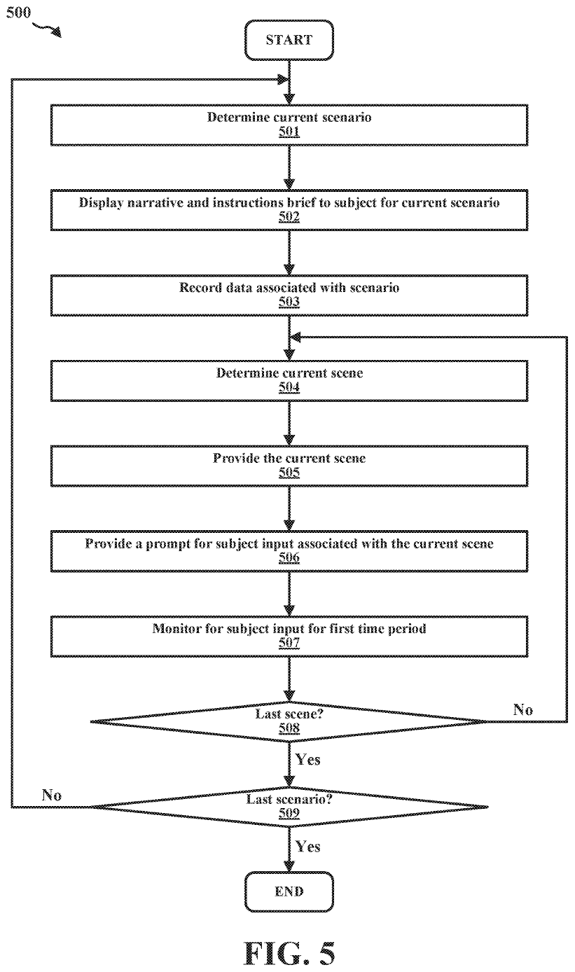

FIG. 5 is a flow diagram illustrating an example method 500 of providing a VR experience associated with an assessment via the VR system in accordance with some aspects of the disclosure. In some aspects, the method 500 may be an example of performing the assessment via the VR system at 402 of FIG. 4. The method may be performed by the systems illustrated in FIGS. 1 and 2 (e.g., the assessment software 102, or the assessment software 205 and client-side systems 213). An assessment may begin at 501 by identifying a current scenario (where an assessment may include multiple scenarios). For example, the system may determine a particular scenario associated with a current skill or area (e.g., a particular aspect of socio-emotional skills) being assessed. After determining the current scenario to be provided at 501, the system may proceed to display a narrative and instruction brief for the current scenario to the subject at 502.

At 503, the system may begin to record data associated with the scenario. For example, the system may begin recording head tracking data, eye movement/tracking data, and/or VR system input and/or output data (log data). At 504, the system may determine a current scene, the current scene may be determined based on a configured first scene of a current scenario (or for subsequent scenes based on a set of behaviors or responses of the subject). The current scene may include a set of elements such as a set of virtual characters, virtual objects, and other aspects of the virtual environment and an associated set of behaviors (or animations) of the virtual characters, the virtual objects, or the virtual environment and the methods of interacting with the elements of the current scene.

After determining the current scene, the system may provide the current scene to the subject via the VR system at 505. While the system provides the current scene at 505, the recording of data begun at 503 continues to collect assessment data associated with the scene. In some aspects, after providing the scene (or as part of providing the scene) the system may provide a prompt for subject input (e.g., a set of options for responding to something presented during the scene) at 506. The prompt may be a virtual prompt selectable by a controller of the VR system (or a defined interaction with the VR system and/or environment).

The system may monitor for subject input at 507 for a first time period (e.g., displayed to the subject within the VR environment/scene). For example, a subject may be provided with a set time to provide a response before a scenario proceeds to a next scene. Accordingly, the absence of a response within the first time period may be identified as an input to the VR system.

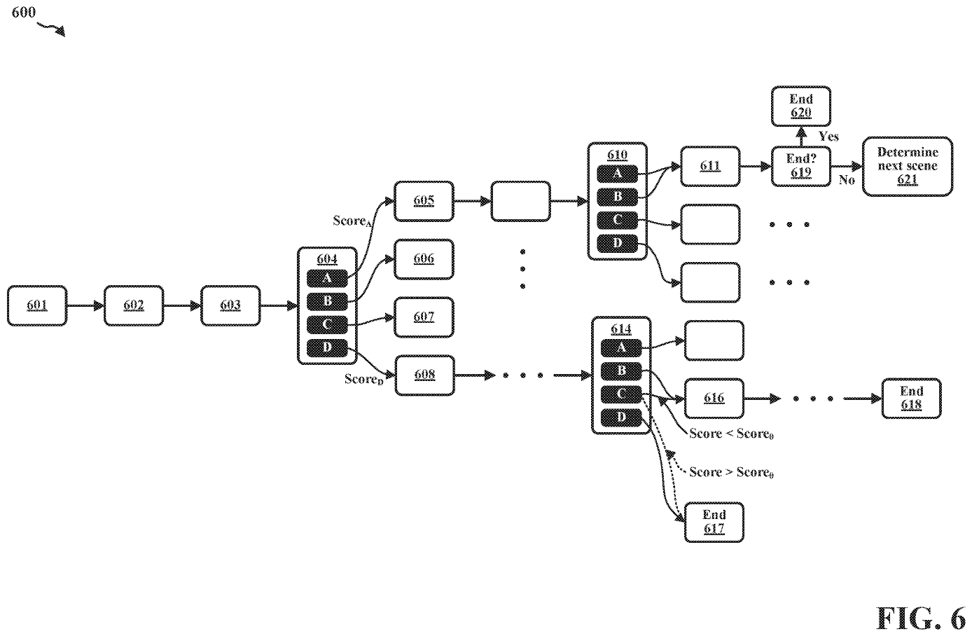

After monitoring for a response at 507, the system may determine if the current scene is a last scene of the scenario at 508. If the current scene is not the last scene of the scenario, the system may return to 504 to determine a current scene. The determination of the current scene at 504, may be based on the input (e.g., a selection or lack of selection of one of a set of prompts/options). For example, in some aspects, each scenario may include a tree structure of scenes with each scene branching into multiple possible scenes based on the input received in response to a prompt provided at the end of the scene. As described in relation to FIG. 6 below

If the scene is determined to be a last scene at 508, the system may determine if the current scenario is a last scenario of the current assessment at 509. If the scenario is determined at 509 to not be a last scenario of the assessment, the system may return to 501 to determine a current scenario (e.g., another scenario associated with another skill or area to be assessed in the current assessment). For example, an evaluation and/or assessment session may include multiple assessments (e.g. for different types of skill areas) with multiple scenarios (e.g., for multiple skills) each including multiple scenes used to test a particular skill or set of skills. If the system determines that the scenario was a last scenario at 509, the method may end. In some aspects, ending the scenario may be the end of performing a current assessment at 402 of FIG. 4 and the method may continue to 403 to determine if a break will be provided or if an additional assessment will be performed (in accordance with the method of FIG. 5) at 404. Accordingly, the recorded data associated with one or more scenarios as described in relation to FIG. 5 may be used to generate a report at 405.

FIG. 6 is a diagram illustrating a structure of a socio-emotional scenario 600 in accordance with some aspects of the disclosure. In the illustrated embodiment, the scenario 600 may begin with a first scene 601 that may be associated with one or more of introducing the scenario, providing instructions for participating in the scenario, and/or a first VR scene e.g., a set of audio/visual stimuli that may include an animation of one or more virtual characters, one or more virtual objects, and/or a virtual environment. The first scene 601 may be followed without user input with a second scene 602, and a third scene 603. At the end of the third scene 603 a set of selectable responses 604 may be presented. The set of selectable responses 604 may include text responses that can be identified using a controller (e.g., using the controller to highlight a candidate response and a trigger to select a currently highlighted response). Alternatively, or additionally, the set of selectable responses 604 may include different virtual objects that may be selected by a subject based on the interactive narrative associated with the scenario and/or third scene 603. The set of selectable responses 604 may include a set of two or more responses (e.g., associated with a selection of element A, B, or C of the set of selectable responses) and may be presented along with a countdown timer indicating a time to select a response before a next scene is initiated. A failure to provide a response within the indicated time may itself be interpreted as a response (e.g., may be associated with a selection of element D of the set of selectable responses 604).

As described above, based on the response received from the set of selectable responses 604, the system may proceed to identify a next scene. For example, if a subject selects element A, the system may identify (e.g., at 504 of FIG. 5) scene 605 as the next scene (e.g., the scenario may proceed to scene 605). Similarly, if the subject selects elements B, C, or D, the system may identify scene 606, 607, or 608, respectively, as the next scene. In some aspects, each selection may be associated with one or more scores associated with a corresponding one or more socio-emotional skills or areas. The one or more scores may be based on the content of the selection and the speed of the selection. For example, a score may be based on whether the selected response is appropriate based on the previously presented scene in the context of the interactive narrative, such as whether (and how quickly) a subject correctly identifies an emotional state of a virtual character when presented with the set of selectable responses 604 indicating multiple candidate emotional states, or whether (and how quickly) a subject responds appropriately to a social cue or situation presented as part of the interactive narrative in a current, or previous, scene. A particular response may be associated with a base score that may be adjusted (e.g., increased or decreased) based on a time remaining for the selection (where a score may be increased by a value based on the total time remaining) or a time elapsed between providing the set of selectable responses 604 and receiving a selection (where the score may be decreased by a value based on the elapsed time).

As for the first scene 601, additional scenes selected and/or identified based on a selection by the subject (e.g., in a series of selections) may be presented and followed by an additional set of selectable responses. For example, scene 605 may lead to the set of selectable responses 610, while scene 608 may lead to the set of selectable responses 614. As illustrated for the set of selectable responses 610, each response may be associated with a particular next scene, but more than one selectable response may be associated with a same next scene based on the interactive narrative (e.g., both elements A and B of the set of selectable responses 610 may be associated with a next scene 611). Alternatively, or additionally, a same selectable response (e.g., element C of the set of selectable response 614) may be associated with two different next scenes (e.g., scene 616 and end scene 617) based on previous responses or on a timing of the response. For example, if a current score for each of a set of assessed skills is above a threshold score (e.g., Score_{θ}) the next scene may be an end scene 617, while if the score for each of the set of assessed skills is not above a threshold score the scenario may continue to scene 616 until an end scene 618. Similarly, an interactive narrative may be designed to have one or more possible “internal” end scenes such as end scene 620 based on an intermediate determination (e.g., determination 619) whether to proceed to end scene 620 that may be selected based on having collected sufficient data to determine a score for one or more assessed skills or skill areas (e.g., having determined scores based on multiple scenes and or selectable sets of responses with a variance below a threshold variance indicating that the collected data represents an actual skill level). However, if the collected data does not appear to be sufficient (e.g., is associated with data points having a variance above the threshold variance indicating that the average may not be an accurate assessment of a skill), the system may proceed to determine a next scene at 621. In some aspects, the determined next scene may be selected from a plurality of options for a continuation of a current scenario where each option may be designed to elicit additional information regarding one or more skills and/or areas for which the collected data may be insufficient.

As described above, and as illustrated in the assessment scenario 600, in some aspects, the assessment scenario 600 may be designed as a static (or semi-static) tree of scenes and sets of selectable responses that is capable of dynamically providing multiple different paths (e.g., representing multiple different VR experiences) based on the subject's responses. The paths may be designed to elicit information for assessing different areas of socio-emotional (or other types of) skills based on feedback from the subject. In some aspects, the determination of the next scene may further be based on one or more sets of sensor data (e.g., EEG, HR, eye tracking, GSR, or other relevant data) that may provide insight into a subject's emotional state such as a raised heart rate associated with stress or other similar (bio-)signals. Accordingly, each subject may be provided a tailored assessment scenario 600 based on the subject's particular feedback, strengths, and weaknesses. In some aspects, the scenes may be designed to test one or more socio-emotional skills or skill areas such as empathy, assertiveness, self-regulation, communication, social perception, conflict management, social learning, self-awareness, self-esteem, or resilience. As described above, the data associated with the scenes provided to the subject, the data collected by the VR system (e.g., regarding head position and orientation, controller position and orientation, eye movement tracking, etc.), and the set of responses (and response times) may be logged in a behavioral log for batch processing at the end of a scenario or multiple scenarios included in an evaluation session or assessment.

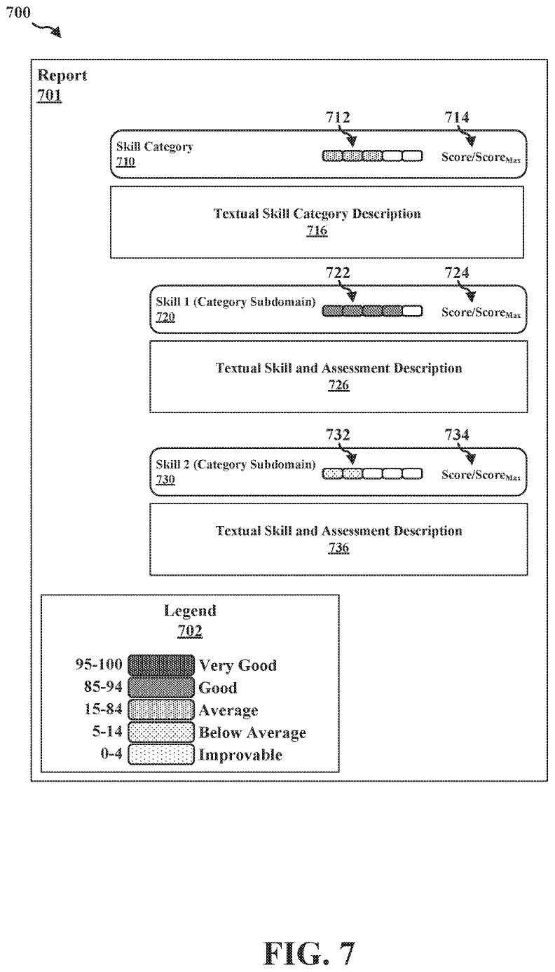

FIG. 7 is a diagram 700 illustrating an example of a generated report 701 in accordance with some aspects of the disclosure. In the illustrated example, the generated report 701 may include a score 714 relating to a skill category 710 and an indication 712 of where a subject stands in comparison to other subjects and/or the general population. The score 714 may be presented as a score 714 out of a maximum score. The score 714 for the skill category 710 may be followed by a textual skill category description 716 (e.g., a text description of the skill category and the interpretation of the subject's score).

Similarly, the generated report 701 may include a score 724 relating to a first skill 720 and an indication 722 of where a subject stands in comparison to other subjects and/or the general population. The score 724 may be presented as a score 724 out of a maximum score. The score 724 for the first skill 720 may be followed by a textual and assessment description 726 (e.g., a text description of the first skill and the interpretation of the subject's score). The generated report 701 may also include a score 734 relating to one or more additional skills such as a second skill 730 and an indication 732 of where a subject stands in comparison to other subjects and/or the general population. The score 734 may be presented as a score 734 out of a maximum score. The score 734 for the second skill 730 may be followed by a textual and assessment description 736 (e.g., a text description of the second skill and the interpretation of the subject's score). In some aspects, a legend 702 may be provided regarding the meaning of the indications 712, 722, and 732.

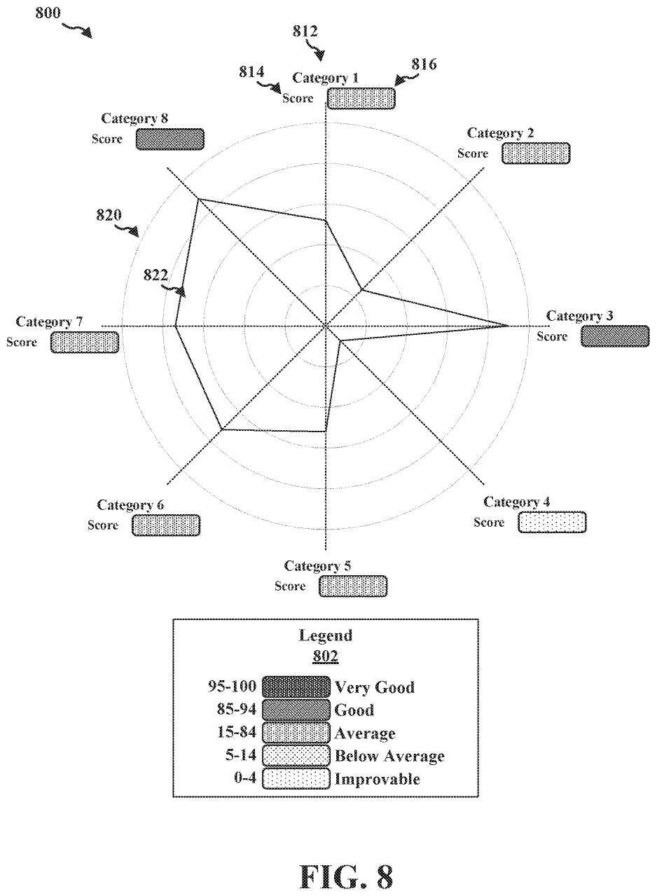

FIG. 8 is a graph diagram illustrating an example graphical representation 800 of the assessment that may be included in a generated report in accordance with some aspects of the disclosure. For example, the illustrated embodiment shows that a radar graph 820 may represent a subject's score for a plurality of skills and/or areas using a set of points defining the area 822. For example, the radar graph 820, in some aspects, may include an axis for each of a set of assessed areas (and/or categories) of socio-emotional or other assessed skills or skill areas and a set of rings representing a set of reference values and/or scores along the axes). Each skill category may be represented by a title 812, a score 814 and an indication 816 of how the subject compares to others (e.g., using a coarser scale, such as improvable, below average, average, good, and very good at or other terms as appropriate). In some aspects, a legend 802 may be provided regarding the meaning of the indication 816 of how the subject compares to others.

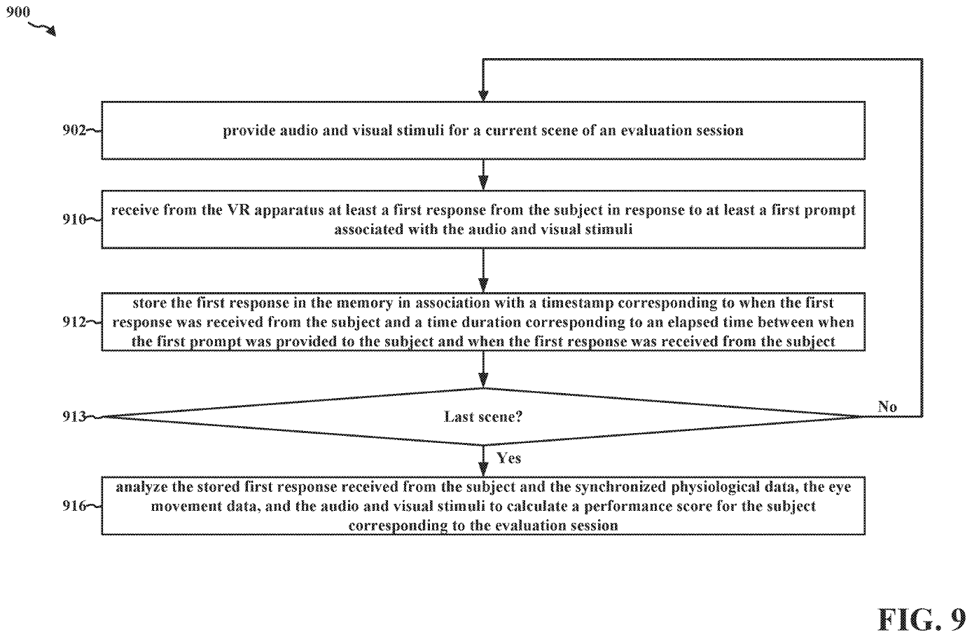

FIG. 9 is a flow diagram illustrating a method 900 in accordance with some aspects of the disclosure. The method, in some aspects, may be performed by the system 100 (or the assessment software 102) or the computer device 1105. At 902, the system may provide audio and visual stimuli in association with a current scene of an evaluation session. In some aspects, the current scene may be an introduction corresponding to the evaluation session. In some aspects, the evaluation session may include a plurality of scenes, each scene having one or more of one or more virtual characters (e.g., one or more virtual characters configured to provide realistic facial expressions based on motion capture data), one or more animations applied to the one or more virtual characters, displayed text, audio vocalizations of at least a portion of the displayed text, and one or more virtual user interface elements configured to register one or more responses from the subject during the evaluation session. Accordingly, providing the audio and visual stimuli at 902, in some aspects, may include providing audio and visual stimuli corresponding to any of the plurality of scenes (e.g., a first scene of the evaluation session, a second scene of the evaluation session, etc.). The audio and visual stimuli corresponding to a particular scene of the plurality of scenes, in some aspects, may include a prompt (e.g., corresponding to the set of selectable responses 604, 610, or 614). In some aspects, the system may provide the introduction via a VR apparatus (e.g., VR system 110) configured to provide audio and visual stimuli to a subject during an evaluation session.

In some aspects, in addition, the system may receive collected eye movement data. In some aspects, the eye movement data may be received from the VR apparatus (e.g., from an integrated eye movement tracker). In some aspects, the system may store the eye movement data in a memory. In some aspects the system may receive physiological data and store the physiological data in the memory.

At 910, the system may receive (e.g., from the VR apparatus) a response to a prompt from the subject during a current scene. In some aspects, the response received at 910 may include a failure to respond within a threshold time. At 912, the system may store the response in association with a timestamp corresponding to when the first response was received from the subject and a time duration corresponding to an elapsed time between when the prompt was provided to the subject and when the response was received from the subject. In some aspects, in addition, to receiving the response at 910, the system may receive collected eye movement data and store the eye movement data in a memory. In some aspects, the eye movement data may be received from the VR apparatus (e.g., from an integrated eye movement tracker). In some aspects the system may receive physiological data and store the physiological data in the memory.

At 913, the system may determine whether a current scene is a last scene of a scenario or assessment. In some aspects, the determining, at 913, in some aspects, may include selecting, based on the response received at 910, a next current scene for the evaluation session the system and return to provide the audio and visual stimuli associated with the selected scene at 902 and continue to deliver scenes to the subject and receive responses from the subject until a last scene in the plurality of scenes for the evaluation session has been provided. In some aspects, selecting the next current scene from a plurality of candidate scenes based on the response received at 910. In some aspects, the second scene may include a behavior of at least one of the one or more virtual characters corresponding to the response received at 910 (e.g., corresponding to a particular received response or a failure to respond within a threshold time).

If the system determines that the current scene is a last scene, the system may synchronize in time the stored physiological data and the stored eye movement data with the audio and visual stimuli provided during the evaluation session (e.g., including one or more scenarios). At 916, the system may analyze the stored responses from the subject and the corresponding timestamps and time durations to calculate at least one skill score for the subject related to the evaluation session. In some aspects, the skill score for the subject includes a set of skill scores associated with a corresponding set of socio-emotional skills. In some aspects, the data collected in relation to a selection of a set of selectable responses (e.g., a selected TO, DO, or AO) may correspond to one or more relevant socio-emotional skill scores (with different weights for different options) previously determined for that option. A subject's score may then be standardized using z-score normalization. The subject's score in the relevant socio-emotional skill may be compared with the previously collected data of other subjects. According to the subject's position on the Normal Gaussian distribution curve, the subject's score in the relevant socio-emotional skill may be calculated. The set of socio-emotional skills, in some aspects, may include skills related to one or more of empathy, assertiveness, self-regulation, communication, social perception, conflict management, social learning, self-awareness, self-esteem, or resilience.

In some aspects, the system may provide, to the subject, an output indicating the calculated at least one skill score. The output, in some aspects, may indicate a first subset of socio-emotional skills for which the subject meets a first corresponding set of threshold levels and a second subset of socio-emotional skills for which the subject does not meet a second corresponding set of threshold levels. In some aspects, the output may indicate the set of skill scores using a first scale and a second scale at different levels of granularity or of different types (e.g., a qualitative scale and a quantitative scale), a description of the set of socio-emotional skills, and an explanation of how the subject performed as described, for example, in relation to FIG. 6. In some aspects, the output may include a graphical summary of the set of skill scores as described, for example, in relation to FIG. 7.

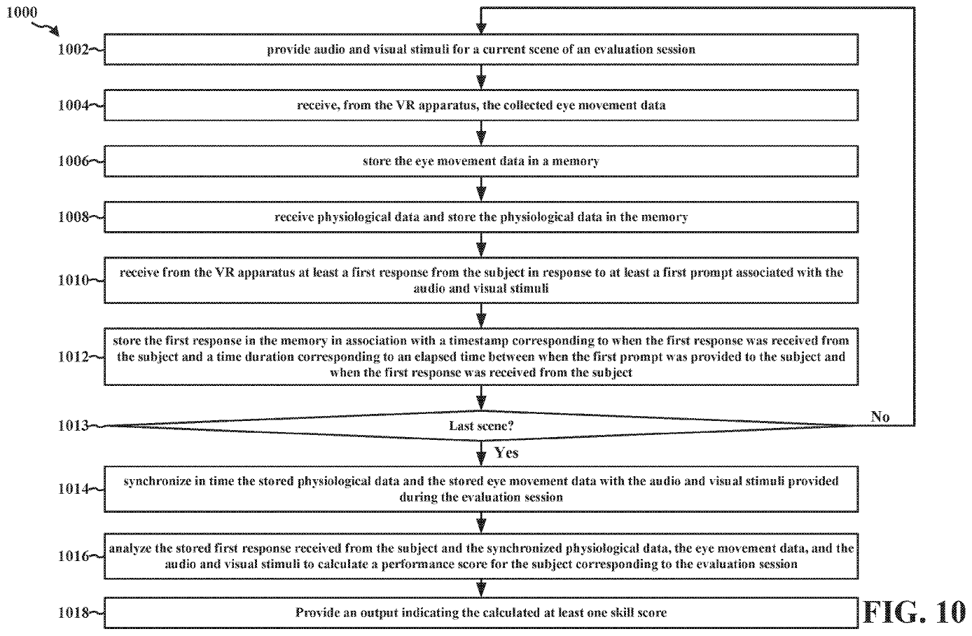

FIG. 10 is a flow diagram illustrating a method 1000 in accordance with some aspects of the disclosure. The method, in some aspects, may be performed by the system 100 (or the assessment software 102) or the computer device 1105. At 1002, the system may provide audio and visual stimuli in association with a current scene of an evaluation session. In some aspects, the current scene may be an introduction corresponding to the evaluation session. In some aspects, the evaluation session may include a plurality of scenes, each scene having one or more of one or more virtual characters (e.g., one or more virtual characters configured to provide realistic facial expressions based on motion capture data), one or more animations applied to the one or more virtual characters, displayed text, audio vocalizations of at least a portion of the displayed text, and one or more virtual user interface elements configured to register one or more responses from the subject during the evaluation session. Accordingly, providing the audio and visual stimuli at 1002, in some aspects, may include providing audio and visual stimuli corresponding to any of the plurality of scenes (e.g., a first scene of the evaluation session, a second scene of the evaluation session, etc.). The audio and visual stimuli corresponding to a particular scene of the plurality of scenes, in some aspects, may include a prompt (e.g., corresponding to the set of selectable responses 604, 610, or 614). In some aspects, the system may provide the introduction via a VR apparatus (e.g., VR system 110) configured to provide audio and visual stimuli to a subject during an evaluation session.

At 1004, the system may receive collected eye movement data. In some aspects, the eye movement data may be received from the VR apparatus (e.g., from an integrated eye movement tracker). At 1006, the system may store the eye movement data in a memory. In some aspects the system may receive, at 1008, physiological data and store the physiological data in the memory.

At 1010, the system may receive (e.g., from the VR apparatus) a response to a prompt from the subject during a current scene. In some aspects, the response received at 1010 may include a failure to respond within a threshold time. At 1012, the system may store the response in association with a timestamp corresponding to when the first response was received from the subject and a time duration corresponding to an elapsed time between when the prompt was provided to the subject and when the response was received from the subject.

At 1013, the system may determine whether a current scene is a last scene of a scenario or assessment. In some aspects, the determining, at 1013, in some aspects, may include selecting, based on the response received at 1010, a next current scene for the evaluation session the system and return to provide the audio and visual stimuli associated with the selected scene at 1002 and continue to deliver scenes to the subject and receive responses from the subject until a last scene in the plurality of scenes for the evaluation session has been provided. In some aspects, selecting the next current scene from a plurality of candidate scenes based on the response received at 1010. In some aspects, the second scene may include a behavior of at least one of the one or more virtual characters corresponding to the response received at 1010 (e.g., corresponding to a particular received response or a failure to respond within a threshold time).

If the system determines that the current scene is a last scene, the system may, at 1014, synchronize in time the stored physiological data and the stored eye movement data with the audio and visual stimuli provided during the evaluation session (e.g., including one or more scenarios). At 1016, the system may analyze the stored responses from the subject and the corresponding timestamps and time durations to calculate at least one skill score for the subject related to the evaluation session. In some aspects, the skill score for the subject includes a set of skill scores associated with a corresponding set of socio-emotional skills. In some aspects, the data collected in relation to a selection of a set of selectable responses (e.g., a selected TO, DO, or AO) may correspond to one or more relevant socio-emotional skill scores (with different weights for different options) previously determined for that option. A subject's score may then be standardized using z-score normalization. The subject's score in the relevant socio-emotional skill may be compared with the previously collected data of other subjects. According to the subject's position on the Normal Gaussian distribution curve, the subject's score in the relevant socio-emotional skill may be calculated. The set of socio-emotional skills, in some aspects, may include skills related to one or more of empathy, assertiveness, self-regulation, communication, social perception, conflict management, social learning, self-awareness, self-esteem, or resilience.

At 1018, the system may provide, to the subject, an output indicating the calculated at least one skill score. The output, in some aspects, may indicate a first subset of socio-emotional skills for which the subject meets a first corresponding set of threshold levels and a second subset of socio-emotional skills for which the subject does not meet a second corresponding set of threshold levels. In some aspects, the output may indicate the set of skill scores using a first scale and a second scale at different levels of granularity, a description of the set of socio-emotional skills, and an explanation of how the subject performed as described, for example, in relation to FIG. 6. In some aspects, the output may include a graphical summary of the set of skill scores as described, for example, in relation to FIG. 7.

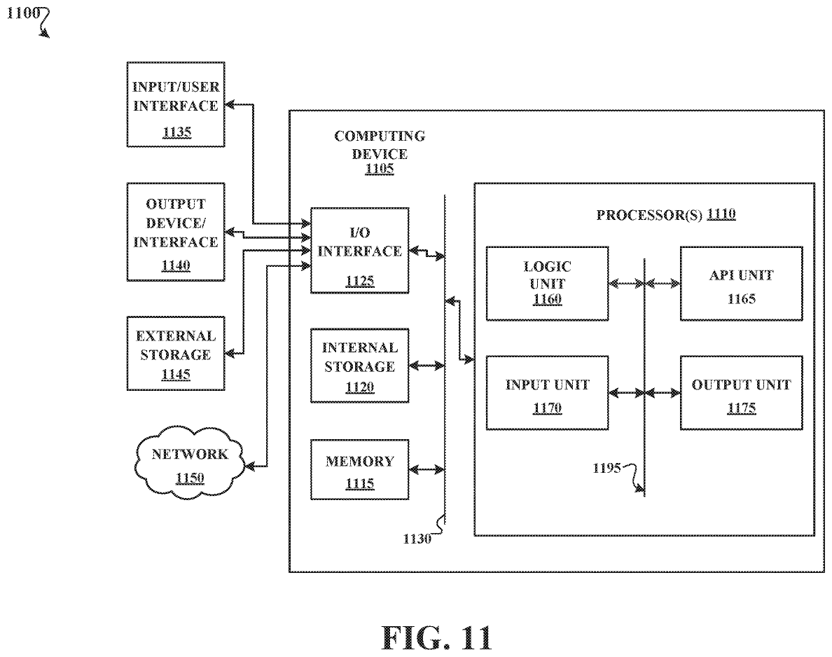

FIG. 11 illustrates an example computing environment with an example computer device suitable for use in some example implementations. Computer device 1105 in computing environment 1100 can include one or more processing units, cores, or processors 1110, memory 1115 (e.g., RAM, ROM, and/or the like), internal storage 1120 (e.g., magnetic, optical, solid-state storage, and/or organic), and/or IO interface 1125, any of which can be coupled on a communication mechanism or bus 1130 for communicating information or embedded in the computer device 1105. In one aspect, the one or more processors 1110 are configured to execute executable programs stored in memory 1115 or internal storage 1120. IO interface 1125 is also configured to receive images from cameras or provide images to projectors or displays, depending on the desired implementation.

Computer device 1105 can be communicatively coupled to input/user interface 1135 and output device/interface 1140. Either one or both of the input/user interface 1135 and output device/interface 1140 can be a wired or wireless interface and can be detachable. Input/user interface 1135 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 1140 may include a display, television, monitor, printer, speaker, braille, or the like. In some example implementations, input/user interface 1135 and output device/interface 1140 can be embedded with or physically coupled to the computer device 1105. In other example implementations, other computer devices may function as or provide the functions of input/user interface 1135 and output device/interface 1140 for a computer device 1105.

Examples of computer device 1105 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1105 can be communicatively coupled (e.g., via IO interface 1125) to external storage 1145 and network 1150 for communicating with any number of networked components, devices, and systems, including one or more computer devices of the same or different configuration. Computer device 1105 or any connected computer device can be functioning as, providing services of, or referred to as a server, client, thin server, general machine, special-purpose machine, or another label.

IO interface 1125 can include but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 1100. Network 1150 can be any network or combination of networks (e.g., the Internet, local area network, wide area network, a telephonic network, a cellular network, satellite network, and the like).

Computer device 1105 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 1105 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) 1110 can execute under any operating system (OS) (not shown), in a native or virtual environment. One or more applications can be deployed that include logic unit 1160, application programming interface (API) unit 1165, input unit 1170, output unit 1175, and inter-unit communication mechanism 1195 for the different units to communicate with each other, with the OS, and with other applications (not shown). The described units and elements can be varied in design, function, configuration, or implementation and are not limited to the descriptions provided. Processor(s) 1110 can be in the form of hardware processors such as central processing units (CPUs) or in a combination of hardware and software units.

In some example implementations, when information or an execution instruction is received by API unit 1165, it may be communicated to one or more other units (e.g., logic unit 1160, input unit 1170, output unit 1175). In some instances, logic unit 1160 may be configured to control the information flow among the units and direct the services provided by API unit 1165, the input unit 1170, the output unit 1175, in some example implementations described above. For example, the flow of one or more processes or implementations may be controlled by logic unit 1160 alone or in conjunction with API unit 1165. The input unit 1170 may be configured to obtain input for the calculations described in the example implementations, and the output unit 1175 may be configured to provide an output based on the calculations described in example implementations.

Processor(s) 1110 can be configured to control an evaluation session to provide an introduction corresponding to the evaluation session, wherein the evaluation session comprises a plurality of scenes, each scene having one or more of one or more virtual characters, one or more animations applied to the one or more virtual characters, displayed text, audio vocalizations of at least a portion of the displayed text, and one or more virtual user interface elements configured to register one or more responses from the subject during the evaluation session. The processor(s) 1110 can be configured to control a VR apparatus to provide audio and visual stimuli corresponding to a first scene of the plurality of scenes for the evaluation session, wherein the audio and visual stimuli comprise at least a first prompt. The processor(s) 1110 can be configured to receive from the VR apparatus a first response to the first prompt from the subject. The processor(s) 1110 can be configured to store the first response in the non-transitory computer readable medium in association with a timestamp corresponding to when the first response was received from the subject and a time duration corresponding to an elapsed time between when the first prompt was provided to the subject and when the first response was received from the subject. The processor(s) 1110 can be configured to select, based on the first response, a second scene for the evaluation session. The processor(s) 1110 can be configured to control the VR apparatus to provide audio and visual stimuli corresponding to the second scene of the plurality of scenes for the evaluation session, wherein the audio and visual stimuli comprise at least a second prompt. The processor(s) 1110 can be configured to receive from the VR apparatus a second response to the second prompt from the subject. The processor(s) 1110 can be configured to store the second response in the non-transitory computer readable medium in association with a timestamp corresponding to when the second response was received from the subject and a time duration corresponding to an elapsed time between when the second prompt was provided to the subject and when the second response was received from the subject. The processor(s) 1110 can be configured to select, based on the second response, a third scene for the evaluation session. The processor(s) 1110 can be configured to continue to deliver scenes to the subject and receive responses from the subject until a last scene in the plurality of scenes for the evaluation session has been delivered. The processor(s) 1110 can be configured to. The processor(s) 1110 can be configured to analyze the stored responses from the subject and the corresponding timestamps and time durations to calculate a skill score for the subject related to the evaluation session.

The processor(s) 1110 can also be configured to select the second scene from a plurality of candidate scenes based on the first response, wherein the second scene comprises a behavior of at least one of the one or more virtual characters corresponding to the first response. The processor(s) 1110 can also be configured to provide, to the subject, an output indicating a first subset of socio-emotional skills for which the subject meets a first corresponding set of threshold levels and a second subset of socio-emotional skills for which the subject does not meet a second corresponding set of threshold levels. The processor(s) 1110 can also be configured to provide, to the subject, an output indicating the set of skill scores using a first scale and a second scale at different levels of granularity, a description of the set of socio-emotional skills, and an explanation of how the subject performed. The processor(s) 1110 can also be configured to provide, to the subject, a graphical summary of the set of skill scores. The processor(s) 1110 can also be configured to collect eye movement data related to one or more of eye movements, eye saccades, or eye fixations while providing a scene. The processor(s) 1110 can also be configured to receive from the VR apparatus collected eye movement data associated with at least one scene. The processor(s) 1110 can also be configured to store the collected eye movement data in association with a timestamp corresponding to when the eye movement data was collected by the VR apparatus, wherein to calculate the skill score for the subject related to the evaluation session the processor is configured to analyze the stored collected eye movement data. The processor(s) 1110 can also be configured to continue to deliver scenes to the subject and receive responses from the subject until a last scene in a first plurality of scenes and a second plurality of scenes for the evaluation session has been provided.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A system comprising:
a non-transitory computer readable medium configured to store information and executable programmed modules;
a virtual reality (VR) apparatus configured to provide audio and visual stimuli to a subject during an evaluation session; and
a processor communicatively coupled with the non-transitory computer readable medium and the VR apparatus, the processor configured to execute programmed modules stored in the non-transitory computer readable medium, the processor configured to:
control the evaluation session to provide an introduction corresponding to the evaluation session, wherein the evaluation session comprises a plurality of scenes, each scene having one or more of one or more virtual characters, one or more animations applied to the one or more virtual characters, displayed text, audio vocalizations of at least a portion of the displayed text, and one or more virtual user interface elements configured to register one or more responses from the subject during the evaluation session;
control the VR apparatus to provide audio and visual stimuli corresponding to a first scene of the plurality of scenes for the evaluation session, wherein the audio and visual stimuli comprise at least a first prompt;
receive from the VR apparatus a first response to the first prompt from the subject;
store the first response in the non-transitory computer readable medium in association with a timestamp corresponding to when the first response was received from the subject and a time duration corresponding to an elapsed time between when the first prompt was provided to the subject and when the first response was received from the subject;
select, based on the first response, a second scene for the evaluation session;
control the VR apparatus to provide audio and visual stimuli corresponding to the second scene of the plurality of scenes for the evaluation session, wherein the audio and visual stimuli comprise at least a second prompt;
receive from the VR apparatus a second response to the second prompt from the subject;
store the second response in the non-transitory computer readable medium in association with a timestamp corresponding to when the second response was received from the subject and a time duration corresponding to an elapsed time between when the second prompt was provided to the subject and when the second response was received from the subject;
select, based on the second response, a third scene for the evaluation session;
continue to deliver scenes to the subject and receive responses from the subject until a last scene in the plurality of scenes for the evaluation session has been delivered; and
analyze the stored responses from the subject and the corresponding timestamps and time durations to calculate a skill score for the subject related to the evaluation session.

2. The system of claim 1, wherein to select the second scene, the processor is configured to:
select the second scene from a plurality of candidate scenes based on the first response, wherein the second scene comprises a behavior of at least one of the one or more virtual characters corresponding to the first response.

3. The system of claim 1, wherein the first response comprises a failure to respond within a threshold time, and the second scene is associated with the failure to respond within the threshold time.

4. The system of claim 1, wherein the one or more virtual characters are configured to provide realistic facial expressions based on motion capture data.

5. The system of claim 1, wherein the skill score for the subject comprises a set of skill scores associated with a corresponding set of socio-emotional skills.

6. The system of claim 5, wherein the set of socio-emotional skills comprises skills related to one or more of empathy, assertiveness, self-regulation, communication, social perception, conflict management, social learning, self-awareness, self-esteem, or resilience.

7. The system of claim 5, wherein the processor is further configured to:
provide, to the subject, an output indicating a first subset of socio-emotional skills for which the subject meets a first corresponding set of threshold levels and a second subset of socio-emotional skills for which the subject does not meet a second corresponding set of threshold levels.

8. The system of claim 5, wherein the processor is further configured to:
provide, to the subject, an output indicating the set of skill scores using a first scale and a second scale at different levels of granularity, a description of the set of socio-emotional skills, and an explanation of how the subject performed.

9. The system of claim 5, wherein the processor is further configured to:
provide, to the subject, a graphical summary of the set of skill scores.

10. The system of claim 1, wherein the VR apparatus is further configured to:
collect eye movement data related to one or more of eye movements, eye saccades, or eye fixations while providing a scene.

11. The system of claim 10, wherein the processor is further configured to:
Receive, from the VR apparatus, collected eye movement data associated with at least one scene; and
store the collected eye movement data in association with a timestamp corresponding to when the eye movement data was collected by the VR apparatus, wherein to calculate the skill score for the subject related to the evaluation session the processor is configured to analyze the stored collected eye movement data.

12. The system of claim 1, wherein the plurality of scenes is a first plurality of scenes associated with a first interactive narrative and the evaluation session comprises at least a second plurality of scenes associated with a second interactive narrative, wherein each scene of the second plurality of scenes has one or more of one or more additional virtual characters, one or more animations applied to the one or more additional virtual characters, additional displayed text, additional audio vocalizations of at least a portion of the additional displayed text, and one or more additional virtual user interface elements configured to register one or more additional responses from the subject during the evaluation session, and the processor is further configured to continue to deliver scenes to the subject and receive responses from the subject until the last scene in the first plurality of scenes and the second plurality of scenes for the evaluation session has been provided.

13. A method comprising:
providing, via a virtual reality (VR) apparatus configured to provide audio and visual stimuli to a subject during an evaluation session, an introduction corresponding to the evaluation session, wherein the evaluation session comprises a plurality of scenes, each scene having one or more of one or more virtual characters, one or more animations applied to the one or more virtual characters, displayed text, audio vocalizations of at least a portion of the displayed text, and one or more virtual user interface elements configured to register one or more responses from the subject during the evaluation session;
providing, via the VR apparatus, audio and visual stimuli corresponding to a first scene of the plurality of scenes for the evaluation session, wherein the audio and visual stimuli comprise at least a first prompt;
receiving from the VR apparatus a first response to the first prompt from the subject during a first scene;
storing the first response in association with a timestamp corresponding to when the first response was received from the subject and a time duration corresponding to an elapsed time between when the first prompt was provided to the subject and when the first response was received from the subject;
selecting, based on the first response, a second scene for the evaluation session;
providing audio and visual stimuli corresponding to the second scene of the plurality of scenes for the evaluation session, wherein the audio and visual stimuli comprise at least a second prompt;
receiving from the VR apparatus a second response to the second prompt from the subject during the second scene;
storing the second response in association with a timestamp corresponding to when the second response was received from the subject and a time duration corresponding to an elapsed time between when the second prompt was provided to the subject and when the second response was received from the subject;
selecting, based on the second response, a third scene for the evaluation session;
continuing to deliver scenes to the subject and receive responses from the subject until a last scene in the plurality of scenes for the evaluation session has been provided; and
analyzing the stored responses from the subject and the corresponding timestamps and time durations to calculate a skill score for the subject related to the evaluation session.

14. The method of claim 13, wherein selecting the second scene comprises:
selecting the second scene from a plurality of candidate scenes based on the first response, wherein the second scene comprises a behavior of at least one of the one or more virtual characters corresponding to the first response.

15. The method of claim 13,
wherein the first response comprises a failure to respond within a threshold time, and the second scene is associated with the failure to respond within the threshold time; or
wherein the one or more virtual characters are configured to provide realistic facial expressions based on motion capture datal; or
wherein the skill score for the subject comprises a set of skill scores associated with a corresponding set of socio-emotional skills.

16-17. (canceled)

18. The method of claim 17, wherein the set of socio-emotional skills comprises skills related to one or more of empathy, assertiveness, self-regulation, communication, social perception, or conflict management.

19. The method of claim 17, further comprising:
providing, to the subject, an output indicating a first subset of socio-emotional skills for which the subject meets a first corresponding set of threshold levels and a second subset of socio-emotional skills for which the subject does not meet a second corresponding set of threshold levels; or
providing, to the subject, an output indicating the set of skill scores using a first scale and a second scale at different levels of granularity, a description of the set of socio-emotional skills, and an explanation of how the subject performed; or
providing, to the subject, a graphical summary of the set of skill scores.

20-21. (canceled)

22. The method of claim 13, further comprising:
collecting, via the VR apparatus, eye movement data related to one or more of eye movements, eye saccades, or eye fixations while providing at least one scene.

23. The method of claim 22, further comprising:
storing the collected eye movement data in association with a timestamp corresponding to when the eye movement data was collected by the VR apparatus, wherein calculating the skill score for the subject related to the evaluation session comprises analyzing the stored collected eye movement data.

24. The method of claim 13, wherein the plurality of scenes is a first plurality of scenes associated with a first interactive narrative and the evaluation session comprises at least a second plurality of scenes associated with a second interactive narrative, wherein each scene of the second plurality of scenes has one or more of one or more additional virtual characters, one or more animations applied to the one or more additional virtual characters, additional displayed text, additional audio vocalizations of at least a portion of the additional displayed text, and one or more additional virtual user interface elements configured to register one or more additional responses from the subject during the evaluation session, the method further comprising:
continuing to deliver scenes to the subject and receive responses from the subject until the last scene in the first plurality of scenes and the second plurality of scenes for the evaluation session has been delivered, wherein calculating the skill score for the subject related to the evaluation session comprises analyzing the received responses associated with the second plurality of scenes.
